(19) United States
(12) Patent Application Publication
(10) Pub. No.: US 2009/0316302 A1
(43) Pub. Date: Dec. 24, 2009

(54) MAGNETIC HEAD AND MAGNETIC DISK UNIT

(75) Inventor: Kenichiro Aoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/368,683

(22) Filed: Feb. 10, 2009

(30) Foreign Application Priority Data
Jun. 24, 2008 (JP) 2008-164514

(51) Int. Cl. G11B 5/60; G11B 5/127

(52) U.S. Cl. 360/234.3; 360/110; G9B/5.229; G9B/5.04

(57) ABSTRACT

A magnetic head includes: a slider which floats above a recording medium by air flow generated by rotation of the recording medium; and an element forming section fixed to an air outflow side of the slider and formed with an element which accesses the recording medium. The element forming section includes: a recording element having a main magnetic pole which records data in the recording medium; and a reproducing element which is formed closer to the slider than the recording element and which reproduces data recorded in the recording medium. The element forming section further includes: a heat insulation layer formed between the main magnetic pole and the reproducing element; and a heater formed closer to the slider than the heat insulation layer.

### CROSS-REFERENCE TO RELATED APPLICATION

This application is based upon and claims the benefit of priority of the prior Japanese Patent Application No. 2008-164514, filed on Jun. 24, 2008, the entire contents of which are incorporated herein by reference.

### FIELD

The embodiments discussed herein are related to a magnetic head and a magnetic disk unit.

### BACKGROUND

Conventionally, magnetic disk units are internal and external to computers and used widely. In the magnetic disk unit, a magnetic head slider to which a magnetic head is fixed floats up from a magnetic disk surface by air flow caused by rotation of a magnetic disk and in this state, the magnetic head accesses the magnetic disk.

A floating amount of the magnetic head from the magnetic disk surface is reduced year after year in correspondence with high recording density of the magnetic disk and at the present, the floating amount is about 10 nm. Therefore, the floating amount of the head is affected by variation in operating environment such as temperature and atmospheric pressure, and variation in shape of a floating surface (ABS: Air Bearing Surface) of the magnetic head slider, and the floating amount is prone to be varied.

Hence, there is proposed a method in which a heater is incorporated in a magnetic head, the heater is energized to generate heat, and the magnetic head is thermally deformed to adjust the floating amount (see Japanese Laid-open Patent Publication No. 05-20635 and U.S. Pat. No. 5,991,113 for example). According to this method, a leading end of a magnetic pole of the magnetic head is projected as needed, and a gap between the leading end of the magnetic pole and the magnetic disk is reduced. There is also proposed a method in which a sheet resistance of a pulled-out portion of a heater is reduced smaller than that of a portion of the heater closer to the element, heat generating efficiency of the heater is enhanced, and a member having thermal conductivity higher than that of alumina is disposed around the heater (see Japanese Laid-open Patent Publications Nos. 2004-335069 and 2006-53972 for example). There is also proposed a method in which two heaters are disposed in layers or a heater is disposed in a magnetic head which employs a helical coil (see Japanese Laid-open Patent Publications Nos. 2007-287277 and 2006-244692 for example). There is also proposed a method in which in order to enhance the heating efficiency of a heater, a heat insulation layer is disposed, or in order to prevent an overcoat layer from being deformed, a heat insulation layer is disposed (see Japanese Laid-open Patent Publications Nos. 2004-199797 and 2007-280502 for example).

In the magnetic head, a recording element and a reproducing element are disposed side by side down the slider, and it is preferable that the recording element and the reproducing element keep appropriate distances from the magnetic disk. Thus, a jut shape (profile) is important in a jut caused by thermal deformation. Further, the slider floats above the magnetic disk in an inclined attitude due to airflow. Therefore, if a portion of one of the recording element and the reproducing element that is disposed at a position closer to the magnetic disk is relatively largely jutted, a distance between the recording element and the magnetic disk and a distance between the reproducing element and the magnetic disk are largely differentiated.

### SUMMARY

According to an aspect of the invention, a magnetic head includes:

a slider which floats above a recording medium by air flow generated by rotation of the recording medium; and

an element forming section fixed to an air outflow side of the slider and formed with an element which accesses the recording medium,

wherein the element forming section includes:

a recording element having a main magnetic pole which records data in the recording medium,

a reproducing element which is formed closer to the slider than the recording element and which reproduces data recorded in the recording medium,

a heat insulation layer formed between the main magnetic pole and the reproducing element, and

a heater formed closer to the slider than the heat insulation layer.

According to another aspect of the invention, a magnetic disk unit includes:

a recording medium in which information is magnetically recorded;

a magnetic head which has a floating surface and floats such that the floating surface is oriented to a relatively moving recording medium, thereby recording information in the recording medium; and

an electronic circuit which supplies an electric signal to the magnetic head,

wherein the magnetic head includes:

a slider which floats above the recording medium by air flow generated by rotation of the recording medium, and

an element forming section fixed to an air outflow side of the slider and formed with an element which accesses the recording medium, and

wherein the element forming section includes:

a recording element having a main magnetic pole which records data in the recording medium,

a reproducing element which is formed closer to the slider than the recording element and which reproduces data recorded in the recording medium,

a heat insulation layer formed between the main magnetic pole and the reproducing element, and

a heater formed closer to the slider than the heat insulation layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a concrete embodiment of a magnetic disk unit;

FIG. 2 illustrates a magnetic head illustrated in FIG. 1;

FIG. 3 is an enlarged sectional view illustrating a structure of an element forming section of the magnetic head illustrated in FIG. 2;

FIG. 4 illustrates a shape of a heater in the magnetic head illustrated in FIG. 3;

FIG. 5 is an enlarged sectional view illustrating a structure of an element forming section of a magnetic head according to a second embodiment;

FIG. 6 is an enlarged sectional view illustrating a structure of a magnetic head according to a reference example 1;

FIG. 7 is an enlarged sectional view illustrating a structure of a magnetic head according to a reference example 2;

FIG. 8 is an enlarged sectional view illustrating a structure of a magnetic head according to a reference example 3;

FIG. 9 is an enlarged sectional view illustrating a structure of a magnetic head according to a reference example 4;

FIG. 10 is a graph illustrating jutting amounts from the floating surface at the time of energization of the heater in the magnetic heads of the four reference examples;

FIG. 11 is a graph illustrating the jutting amount of the magnetic head illustrated in FIG. 3;

FIG. 12 is a graph illustrating the jutting amount of the magnetic head illustrated in FIG. 5;

FIG. 13 is a table illustrating a difference of a distance between a recording element portion and a magnetic disk surface and a distance between a reproducing element portion and the magnetic disk surface at the time of energization of the heater; and

FIG. 14 is a table illustrating the maximum jutting amount at the time of energization of the heater.

### DESCRIPTION OF EMBODIMENTS

A concrete embodiment of a magnetic head and a magnetic disk unit disclosed herein will be described below.

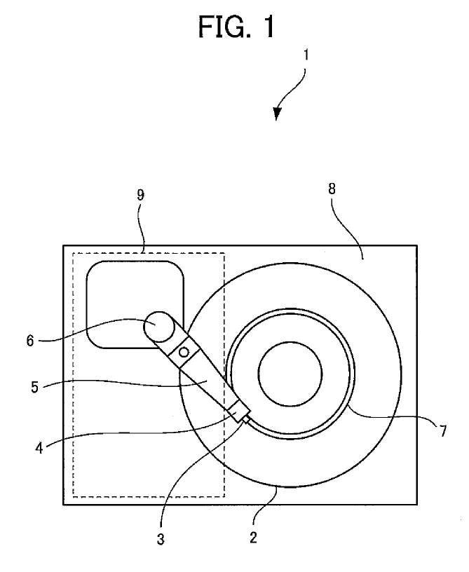

FIG. 1 illustrates the concrete embodiment of the magnetic disk unit.

The magnetic disk unit 1 illustrated in FIG. 1 is provided with a rotary actuator 6 which generates a rotation driving force. The rotary actuator 6 has a rotation axis in a direction perpendicular to the sheet of FIG. 1. The rotary actuator 6 supports a suspension arm 5. The suspension arm 5 receives a rotation driving force of the rotary actuator 6 and turns around the rotary actuator 6 within a plane of FIG. 1. A magnetic head 3 is mounted on a leading end of the suspension arm 5 through a gimbal 4 as a support tool. The magnetic head 3 reads and writes information onto and from a magnetic disk 2 serving as a recording medium.

When reading and writing information, the suspension arm 5 is rotated and driven by the rotary actuator 6, the magnetic head 3 moves to a target position on the magnetic disk 2, and the magnetic head 3 reads and writes information from and onto the magnetic disk 2. A large number of trucks 7 are arranged concentrically on the surface of the magnetic disk 2. In each truck 7, a unit storing region which stores information of one bit called one bit region is arranged along the truck 7. Each one bit region is provided with magnetization orienting in a direction perpendicular to a plane of the magnetic disk 2, and one bit information is represented depending upon direction of the magnetization. The magnetic disk 2 rotates within a plane of the drawing around the center of the disk. The magnetic head 3 disposed near the surface of the magnetic disk 2 approaches the one bit regions of the rotating magnetic disk 2 sequentially.

When information is recorded, an electric recording signal is input to the magnetic head 3 which approaches the magnetic disk 2, the magnetic head 3 applies a magnetic field to each one bit region in accordance with the input recording signal, and information borne by the recording signal is recorded in a form of magnetization direction of each one bit region. When information is reproduced, the magnetic head 3 produces an electric reproducing signal in accordance with a magnetic field generated from the magnetization, thereby taking out information recorded in the form of the magnetization direction in each one bit region. Here, after the magnetic head 3 read information in one of the trucks 7, if information is read or written in another truck 7, the suspension arm 5 which received a rotation driving force of the rotary actuator 6 turns and the magnetic head 3 moves to a position near the other truck 7, and information is read or written in the manner described above in each one bit region of the other truck 7.

The rotary actuator 6, the suspension arm 5, the gimbal 4 and the magnetic head 3 which directly relate to the recording and reproducing operations of information are accommodated in a base 8 together with the magnetic disk 2. FIG. 1 illustrates an inner state of the base 8. A control substrate 9 formed with an electronic circuit which controls the members is provided on a back side of the base 8. The members are electrically conducting with the control substrate 9 through a mechanism (not illustrated), a recording signal which is input to the magnetic head 3 and a reproducing signal produced by the magnetic head 3 are processed in the control substrate 9. The control substrate 9 supplies current to a heater (described later) incorporated in the magnetic head 3, and controls a distance between the magnetic head 3 and the magnetic disk 2.

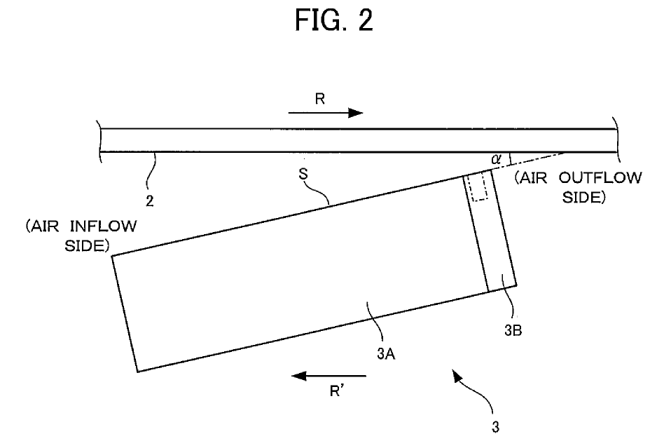

FIG. 2 illustrates the magnetic head illustrated in FIG. 1. FIG. 2 illustrates the magnetic head 3 and the magnetic disk 2.

The magnetic head 3 includes a slider 3A which floats above the magnetic disk 2 by air flow generated by rotation of the magnetic disk 2, and an element forming section 3B which is fixed to an air outflow side of the slider 3A and which is formed with an element accessing the magnetic disk 2. The magnetic head 3 moves in a direction of the arrow R′ relative to the magnetic disk 2 which rotates in the direction of the arrow R. A force in a direction (upward in FIG. 2) coming into contact with the magnetic disk 2 is applied to the magnetic head 3 by the gimbal 4 (see FIG. 1). The magnetic head 3 floats above the magnetic disk 2 (downward in FIG. 2) in such an attitude that the floating surface S is oriented to the magnetic disk 2 by air flowing from the air inflow side to the air outflow side as the magnetic disk 2 rotates. The magnetic head 3 floats in a state where the magnetic head 3 is inclined with respect to the magnetic disk 2 such that an angle α is formed between the floating surface S and the magnetic disk 2.

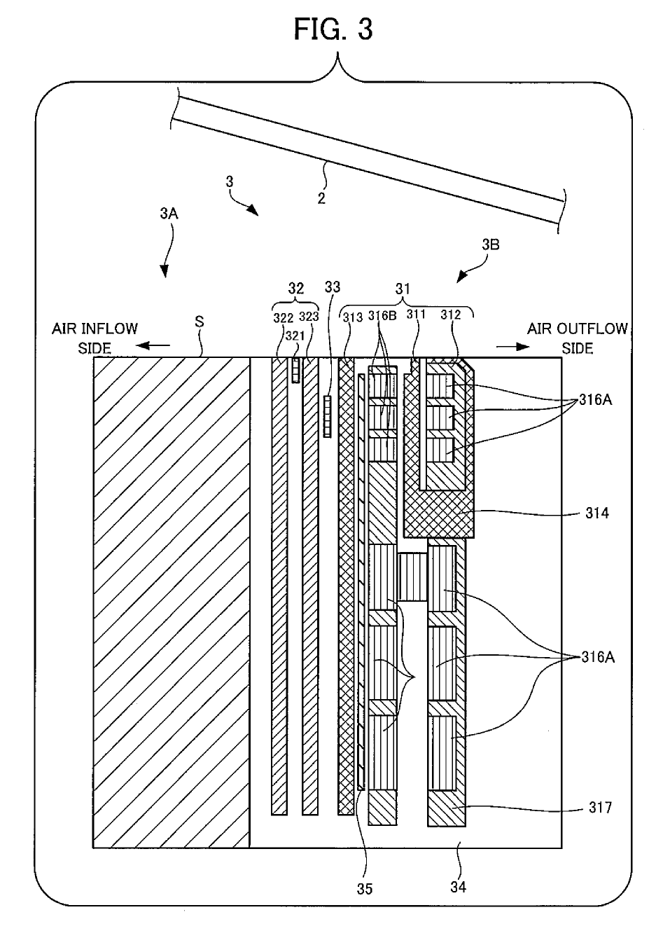

FIG. 3 is an enlarged sectional view illustrating a structure of the element forming section of the magnetic head illustrated in FIG. 2. FIG. 3 illustrates that a portion of the magnetic disk 2 and the magnetic head 3 rotate such that the floating surface S of the magnetic head 3 becomes horizontally.

The element forming section 3B includes a recording element 31 which applies a magnetic field to each one bit region in accordance with a recording signal to record information in a form of magnetization direction when information is recorded, a reproducing element 32 which produces an electric reproducing signal representing information in accordance with the magnetic field generated from magnetization of each one bit region when information is reproduced, a heater 33, and a heat insulation layer 35. The element forming section 3B has such a structure that the recording element 31, the reproducing element 32, the heater 33 and the heat insulation layer 35 are sequentially laminated on the slider 3A which is a support substrate through alumina insulation layer 34. The slider 3A is also called a support substrate 3A.

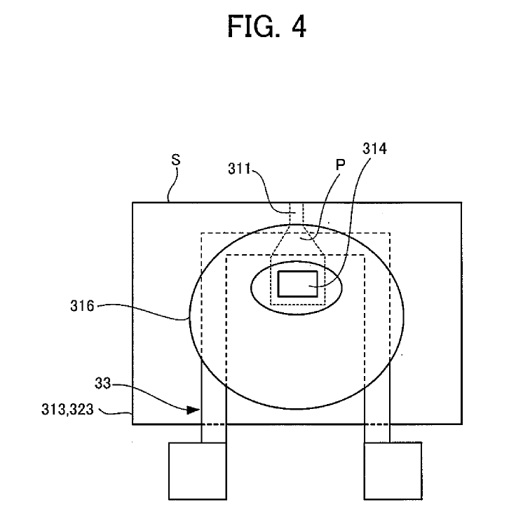

The recording element 31 includes a main magnetic pole 311 which records data on the magnetic disk 2, auxiliary magnetic poles 312 and 313 disposed at locations nipping the main magnetic pole 311, a connection 314 connecting the auxiliary magnetic pole 312 and the main magnetic pole 311 with each other, and thin film coils 316A and 316B which generate a recording magnetic field. The main magnetic pole 311, the auxiliary magnetic poles 312 and 313 and the connection 314 are made of alloy (Ni—Fe) of nickel (Ni) and iron (Fe). An insulation resin 317 is charged around the thin film coils 316A and 316B. In the recording element 31 of the embodiment, a double coil system is employed. The main magnetic pole 311, the connection 314 and the air outflow side first auxiliary magnetic pole 312 of the two auxiliary magnetic poles 312 and 313 form a portion of a first magnetic path of magnetic flux generated at the time of magnetic recording operation. The thin film coil 316A disposed on the air outflow side among the thin film coils 316A and 316B is disposed such that it intersects with the first magnetic path. The main magnetic pole 311 and the air inflow side second auxiliary magnetic pole 313 form a portion of a second magnetic path. The thin film coil 316B disposed on the air inflow side is disposed such that it intersects with the second magnetic path. The main magnetic pole 311 is tapered from the connection 314 toward its tip end opposed to the magnetic disk 2 (see FIG. 4).

The reproducing element 32 reproduces information utilizing giant magnetoresistance effect (GMR effect), and includes a magnetoresistance effect film 321 and magnetic shield layers 322 and 323. The two magnetic shield layers 322 and 323 are disposed at positions nipping the magnetoresistance effect film 321. As the magnetoresistance effect film 321, a film utilizing tunnel magnetoresistance effect (TMR effect) can also be employed in addition to the GMR. The magnetic shield layers 322 and 323 are made of alloy (Ni—Fe) of nickel (Ni) and iron (Fe), and have high permeability.

The heater 33 adjusts a floating amount of the magnetic head 3 from the magnetic disk 2 by thermally deforming the floating surface S of the magnetic head 3. The heat insulation layer 35 is made of material having smaller thermal conductivity than that of the insulation layer 34 so as to prevent heat generated by the heater 33 from being transferred. As material of the heat insulation layer 35, material having thermal conductivity of 1.5/mK or lower and more specifically, amorphous resin of thermal conductivity of 0.1 W/mK is employed. As material of the heat insulation layer 35, in addition to the amorphous resin, the same resist resin (thermal conductivity is 0.3 W/mK) charged around the thin film coils 316A and 316B, and silicon oxide (SiO₂: thermal conductivity is 1.0 W/mK) can also be employed.

The heat insulation layer 35 in the magnetic head 3 of the embodiment is formed between the main magnetic pole 311 of the recording element 31 and the reproducing element 32. More specifically, the heat insulation layer 35 is formed in the recording element 31, and is disposed between the thin film coil 316B on the side of the slider 3A, i.e., the side of the reproducing element 32, and the auxiliary magnetic pole 313. The thickness of the heat insulation layer 35 is about 0.2 μm.

The heater 33 is disposed closer to the slider 3A, i.e., the reproducing element 32 than the heat insulation layer 35. More specifically, the heater 33 is disposed between the recording element 31 and the reproducing element 32, more specifically, the heater 33 is disposed between the thin film coil 316B on the side of the reproducing element 32 of the recording element 31 and the magnetic shield layer 323 on the side of the recording element 31 of the reproducing element 32.

FIG. 4 illustrates the shape of the heater in the magnetic head illustrated in FIG. 3. FIG. 4 illustrates the shape of the heater 33 when the magnetic head is viewed in the moving direction R′.

As illustrated in FIG. 4, the heater 33 has the shape extending toward the floating surface S from two heater joints 331 and 332 as connection terminals, and extending substantially in parallel to the floating surface S. The material of the heater 33 is nickel copper, but tungsten or titanium tungsten can also be employed. As the shape of the heater, a meandering shape can also be employed in addition to the shape illustrated in FIG. 4.

The support substrate 3A is a substrate (AlTiC substrate) formed such that an aluminum oxide film is formed on a non-magnetic surface having aluminum oxide (Al₂O₃) and titanium carbide (Tic).

In the magnetic head 3 illustrated in FIGS. 3 and 4, if current is supplied to the heater 33 from the control substrate 9 (see FIG. 1), the magnetic head 3 is heated from its portion near the heater 33, and the floating surface S is deformed such as to jut toward the magnetic disk 2. The jutting amount of the floating surface S is greater as closer to the heater 33. However, a portion of the floating surface S disposed on the side of the air outflow side as compared with the heat insulation layer 35 where the thin film coils 316A and 316B and the main magnetic pole 311 are disposed has a smaller jutting amount than the portion of the reproducing element 32 because the heat transfer from the heater 33 is hindered.

In the magnetic head 3 illustrated in FIGS. 3 and 4, the reproducing element 32 is formed closer to the slider 3A, i.e., the air inflow side than the recording element 31, and a distance between the reproducing element 32 and the magnetic disk 2 in a state where the slider 3A floats is greater than a distance between the recording element and the magnetic disk 2. When the heater 33 generates heat, the heat from the heater 33 is blocked by the heat insulation layer 35. Therefore, a portion of the reproducing element 32 on the side of the slider 3A of the floating surface S largely juts than the main magnetic pole 311 of the recording element 31 and the reproducing element 32 approaches the magnetic disk 2. Thus, the distance between the recording element 31 and the magnetic disk 2 and the distance between the reproducing element 32 and the magnetic disk 2 are equalized.

In this embodiment, the heater is formed between the heat insulation layer and the reproducing element, but it is only necessary that the heater is formed closer to the slider 3A than the heat insulation layer 35 and closer to the slider than the reproducing element. Next, a concrete second embodiment of the reproducing element magnetic head in which the heater is formed closer to the slider than the reproducing element will be described. In the second embodiment, the same elements as those of the previous embodiment are designated with the same symbols or symbols are omitted, and only portions of the second embodiment which are different from the previous embodiment will be described.

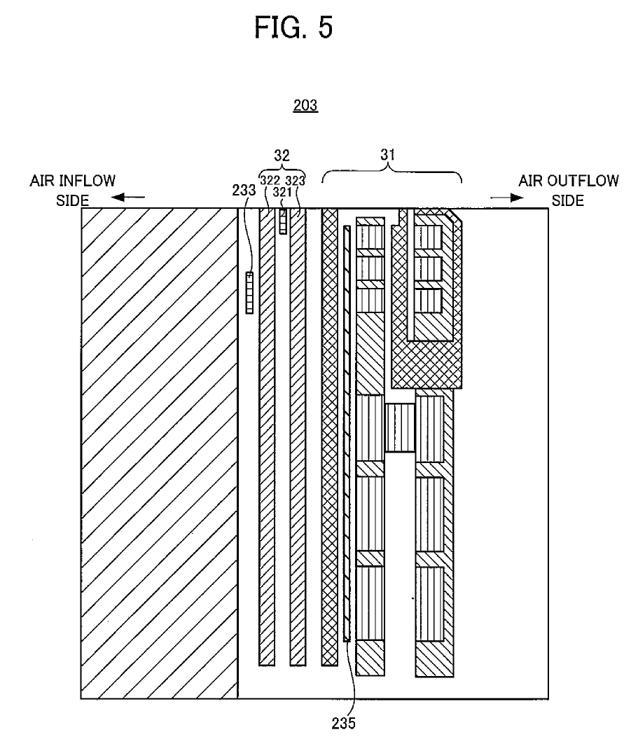

FIG. 5 is an enlarged sectional view illustrating a structure of an element forming section of a magnetic head according to the second embodiment.

A magnetic head 203 illustrated in FIG. 5 is different from the magnetic head 3 of the first embodiment illustrated in FIG. 3 in that a heater 233 is disposed on the air inflow side, i.e., closer to the slider 3A than the reproducing element 32, and the thickness of a heat insulation layer 235 is 0.3 μm.

According to the magnetic head 203 illustrated in FIG. 5, if the heater 233 generates heat, a portion of the reproducing element 32 formed on the side of the slider 3A in the floating surface S largely deforms more than the main magnetic pole 311 of the recording element 31 and approaches the magnetic disk 2. Further, since the heat from the heater 233 is blocked by the heat insulation layer 235, the jutting of the recording element 31 is restrained. Thus, the distance between the recording element 31 and the magnetic disk 2 and the distance between the reproducing element 32 and the magnetic disk 2 are equalized.

Next, jutting amounts of the magnetic heads having different positions of the heaters from the floating surface S are measured.

First, as reference examples, jutting amounts, from the floating surface S, of the magnetic heads which do not have heat insulation layers and which have different positions of the heaters when the heaters are energized are measured.

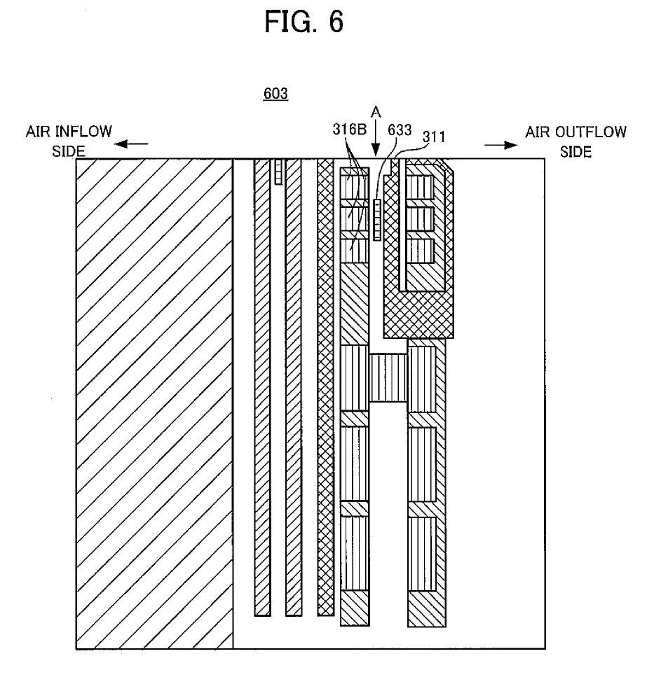

FIG. 6 is an enlarged sectional view illustrating a structure of a magnetic head of the reference example 1.

A magnetic head 603 illustrated in FIG. 6 does not have the heat insulation layer, and the heater 633 is disposed between the main magnetic pole 311 and the thin film coil 316B. The position of the heater 633 is defined as a position A.

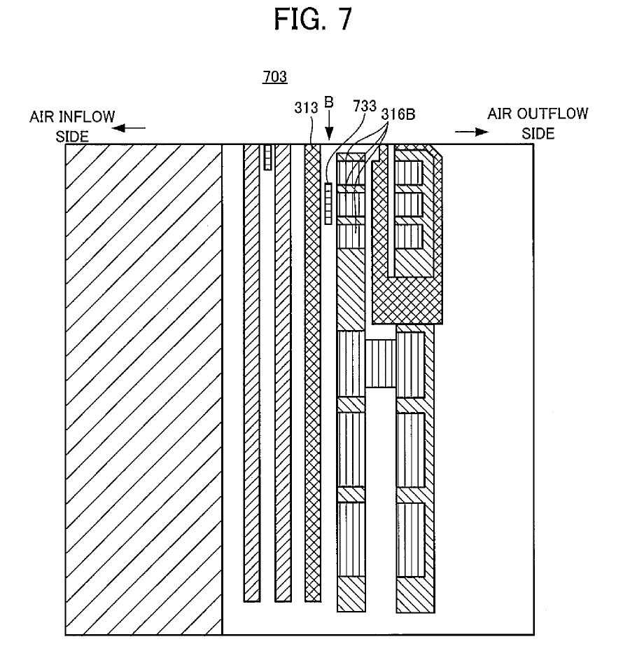

FIG. 7 is an enlarged sectional view illustrating a structure of a magnetic head of the reference example 2.

A magnetic head 703 illustrated in FIG. 7 does not have the heat insulation layer, and the heater 733 is disposed between the thin film coil 316B and the auxiliary magnetic pole 313. The position of the heater 733 is defined as a position B.

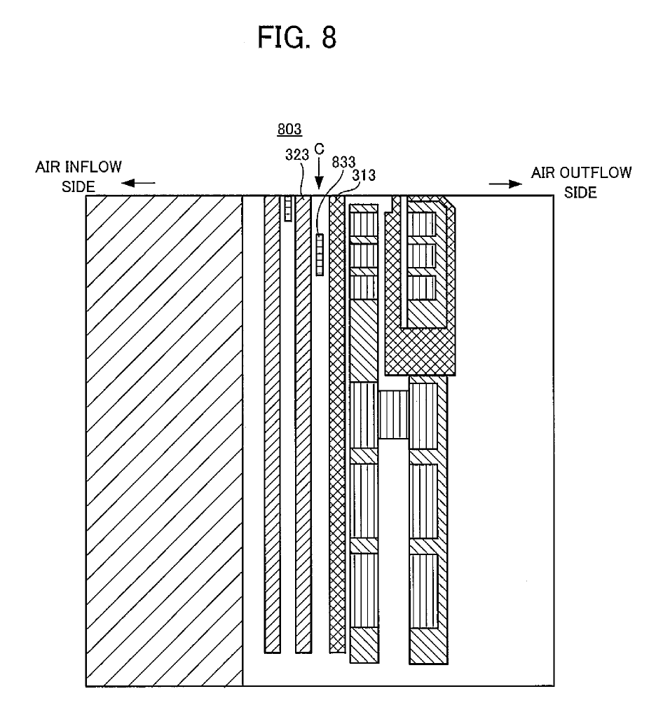

FIG. 8 is an enlarged sectional view illustrating a structure of a magnetic head of the reference example 3.

A magnetic head 803 illustrated in FIG. 8 does not have the heat insulation layer, and the heater 833 is disposed between the auxiliary magnetic pole 313 and the magnetic shield layer 323. The position of the heater 833 is defined as a position C.

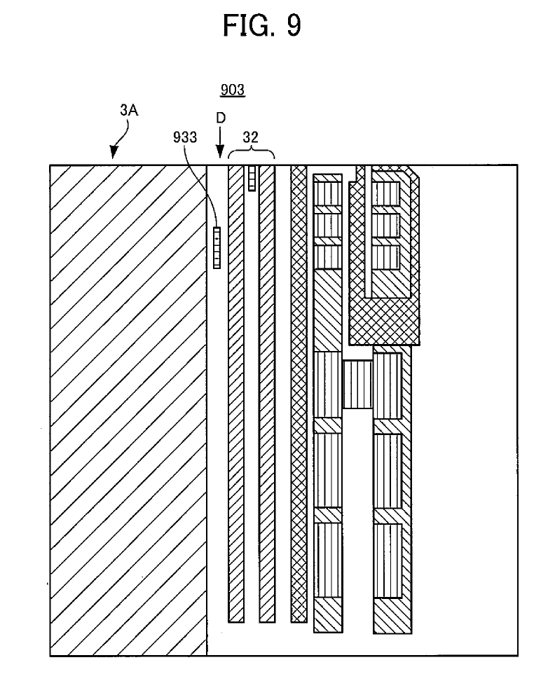

FIG. 9 is an enlarged sectional view illustrating a structure of a magnetic head of the reference example 4.

A magnetic head 903 illustrated in FIG. 9 does not have the heat insulation layer, and the heater 933 is disposed between the reproducing element 32 and the support substrate 3A. The position of the heater 933 is defined as a position D.

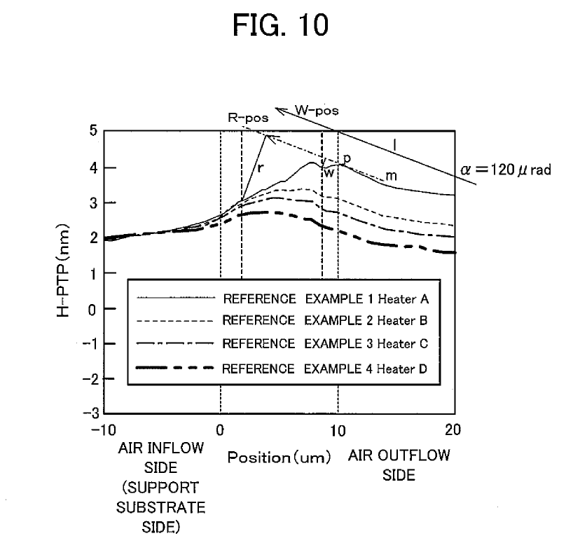

FIG. 10 is a graph illustrating jutting amounts of the magnetic heads of the four reference examples illustrated in FIGS. 6 to 9 from the floating surface when the heaters are energized.

The graph in FIG. 10 illustrates the jutting amounts (H-PTP) of the magnetic heads 603 to 903 of the reference examples illustrated in FIGS. 6 to 9 from the floating surface S when the heaters 633 to 933 are energized as distribution along a direction from the air inflow side to the air outflow side. That is, the graph in FIG. 10 illustrates the shape (profile) of the floating surface S in the moving direction R when the heaters are energized. Here, R-pos in the graph in FIG. 10 represents a position of the magnetoresistance effect film of the reproducing element in the floating surface S, and W-pos represents a position of the main magnetic pole of the recording element. Heat generating amounts of the heaters are 20 mW.

In the reference example 1 in which the heater 633 is disposed at the position A between the main magnetic pole 311 and the thin film coil 316B, if the heater is energized, the jutting amount becomes a maximum in the vicinity of the recording element.

In the order of the reference examples 2, 3 and 4, the maximum jutting portion when the heater is energized is closer to the support substrate 3A as the position of the heater is closer to the support substrate 3A, i.e., closer to the air inflow side. More concretely, in the reference example 2 in which the heater is disposed at the position B between the thin film coil 316B and the auxiliary magnetic pole 313, the maximum jutting amount portion is closer to the support substrate 3A as compared with the reference example 1. In the reference example 3 in which the heater is disposed at the position C between the auxiliary magnetic pole 313 and the magnetic shield layer 323, the maximum jutting amount portion is much closer to the support substrate 3A. In the reference example 4 in which the heater is disposed at the position D between the reproducing element 32 and the support substrate 3A, the maximum jutting amount portion is much closer to the support substrate 3A.

When the heater is not energized, the floating surface is expressed with the straight line H-PTP=0. For example, when the floating surface S of the magnetic head is inclined through 120 μrad with respect to the magnetic disk as expressed with the straight line 1 in FIG. 10, a distance between the portion (W-pos) of the recording element and the magnetic disk and a distance between the portion (R-pos) of the reproducing element and the magnetic disk are different from each other. The portion of the recording element is closer to the magnetic disk than the portion of the reproducing element.

For example, in the reference example 1, when the heater is energized, the jutting amount of the recording element portion becomes greater than the jutting amount of the reproducing element portion. Therefore, the difference of the distance between the recording element and the magnetic disk and the distance between the reproducing element and the magnetic disk is further increased by the deformation of the energization of the heater. From the reference examples 2 to 4, as the position of the heater is closer to the support substrate 3A, the maximum jutting amount portion when the heater is energized becomes closer to the reproducing element. Thus, the difference of the distance between the recording element and the magnetic disk and the distance between the reproducing element and the magnetic disk is reduced. However, if the reference examples 1 to 4 are compared with each other, as the position of the heater becomes closer to the support substrate 3A, the maximum value of the jutting amount (H-PTP) is reduced.

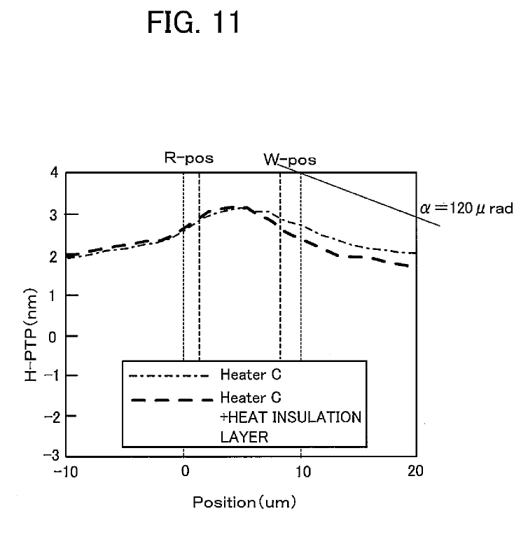

FIG. 11 is a graph illustrating the jutting amount by the energization of the heater in the magnetic head of the first embodiment illustrated in FIG. 3. FIG. 11 illustrates the jutting amount of the magnetic head 3 illustrated in FIG. 3 together with the jutting amount in the reference example 3.

According to the magnetic head 3 illustrated in FIG. 3, the heater is disposed at the position C like the position of the heater in the reference example 3, but the magnetic head 3 is different from the reference example 3 (FIG. 8) in that the magnetic head 3 has the heat insulation layer 35. The heat generating amount of the heater is 20 mW.

According to the magnetic head 3 in which the heat insulation layer 35 is disposed between the thin film coil 316B and the auxiliary magnetic pole 313, the maximum value of the jutting amount is about the same as that of the reference example 3 as illustrated in the graph of FIG. 11, but the jutting amount in the recording element portion (W-pos) is smaller than that of the reference example 3.

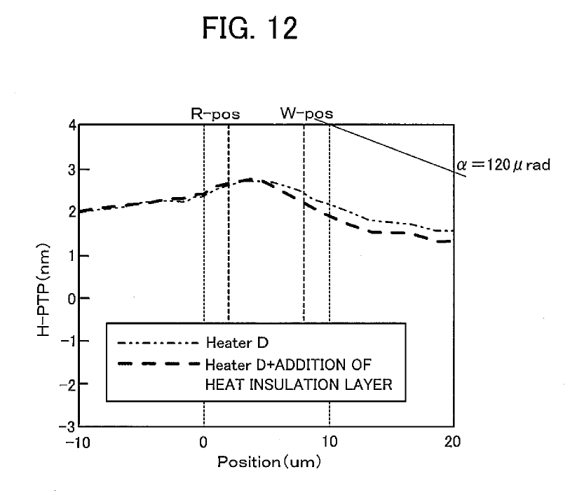

FIG. 12 is a graph illustrating the jutting amount by the energization of the heater in the magnetic head of the second embodiment illustrated in FIG. 5. FIG. 12 illustrates the jutting amount of the magnetic head 203 illustrated in FIG. 5 at the time of energization of the heater together with the jutting amount in the reference example 4.

In the magnetic head 203 illustrated in FIG. 5, the heater is disposed at the position D like the position of the heater in the reference example 4, but is different from the reference example 4 (FIG. 9) in that the magnetic head 203 has the heat insulation layer 35. The heat generating amount of the heater is 20 mW.

In the magnetic head 203 having the heat insulation layer 35, the maximum value of the jutting amount is about the same as that of the reference example 4 as illustrated in the graph in FIG. 12, but the jutting amount of the recording element portion (W-pos) is smaller than that of the reference example 4.

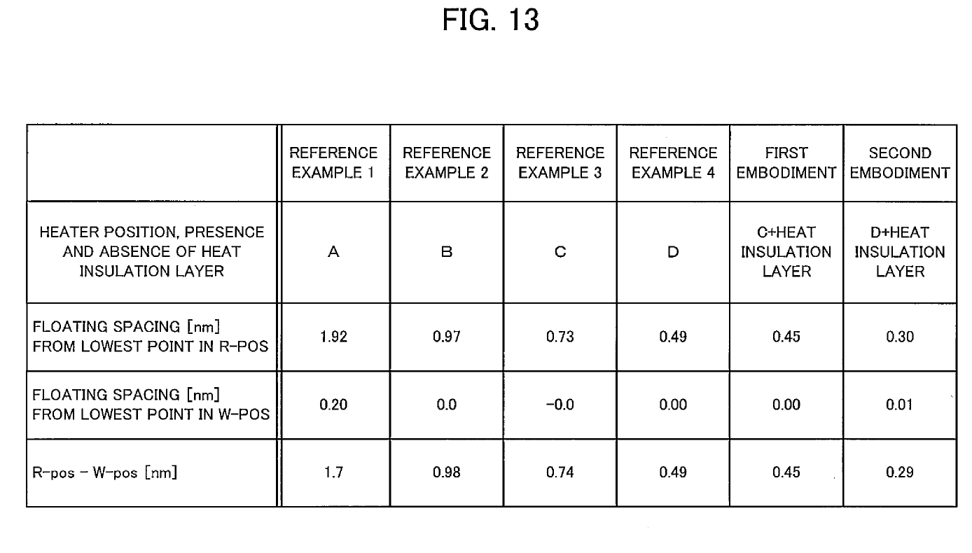

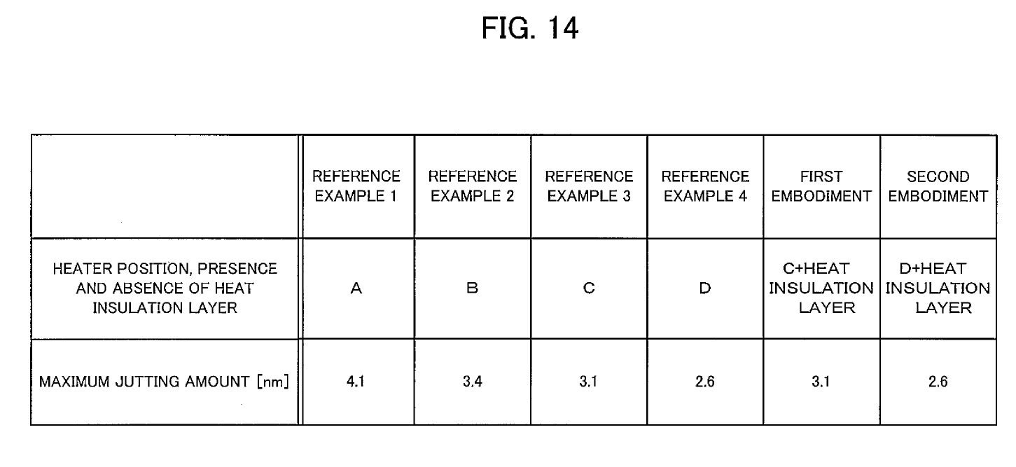

FIG. 13 is a table illustrating differences of the distance between the recording element portion and the magnetic disk and the distance between the reproducing element portion and the magnetic disk at the time of energization of the heaters in the first and second embodiments and the four reference examples. FIG. 14 is a table illustrating maximum jutting amounts at the time of energization of the heaters.

If attention is paid to the reference example 1 (solid line) in the graph in FIG. 10 for example, the minimum of a distance from the straight line 1 where the magnetic disk plane in each point of the floating surface is assumed is defined as the lowest point p. Next, a distance from a straight line m which is parallel to the straight line 1 to the recording element portion (W-pos) of the floating surface passing through the lowest point p, and a distance from the straight line m to the reproducing element portion (R-pos) are illustrated from floating spacing from the lowest point in FIG. 13. FIG. 13 illustrates a difference between the distance from the straight line m to the recording element portion and the distance from the straight line m to the reproducing element portion as R-pos−W-pos. Values of the remaining reference examples and the embodiments are also obtained in the same manner.

As illustrated in the graph in FIG. 10, in the reference example 1 where the heater is disposed at the position A, since the lowest point p (see FIG. 10) exists near the recording element, the floating spacing at the recording element portion is 1.92 nm. A floating spacing at the reproducing element portion is as small as 0.20 nm. As a result, a spacing difference (R-pos−W-pos) is as great as 1.7 nm. In the magnetic head 603 in the reference example 1, it is not easy to bring the reproducing element close to the magnetic disk by energization of the heater, and it is difficult to control the reproducing condition. If the heater is disposed close to the support substrate 3A from the position A, the position B, the position C and the position D from the reference example 1 to reference example 4, the spacing difference is reduced. However, as illustrated in the table in FIG. 14, as the heater is disposed closer to the support substrate 3A from the position A to the position B, the position C and the position D, there is a tendency that the maximum jutting amount is reduced, and efficiency obtained by excessive heat of the heater is lowered.

Here, if the magnetic head 3 of the first embodiment including the heat insulation layer and the heater disposed at the position C and the reference example 3 having the heater disposed at the position C and having no heat insulation layer are compared with each other, the maximum jutting amount is the same as illustrated in the table in FIG. 14. Further, the spacing difference is reduced as illustrated in the table in FIG. 13. That is, the distance between the recording element and the magnetic disk and the distance between the reproducing element and the magnetic disk are equalized. According to the magnetic head 3 of the first embodiment, the spacing difference can be reduced as compared with the reference example 4.

When the magnetic head 203 of the second embodiment including the heater disposed at the position D and the heat insulation layer and the reference example 4 having the heater disposed at the position D and having no heat insulation layer are compared with each other also, the maximum jutting amounts are the same as illustrated in the table in FIG. 14. Further, the spacing difference is reduced as illustrated in the table of FIG. 13. The spacing difference is the smallest in the magnetic head 203 of the second embodiment having the heater disposed at the position D and the heat insulation layer. That is, the distance between the recording element and the magnetic disk and the distance between the reproducing element and the magnetic disk are equalized. However, if the second and first embodiments are compared with each other, the maximum jutting amount is greater in the first embodiment, and the efficiency of deformation caused by heat of the heater is higher.

Although the structure of the vertical recording type magnetic head is indicated as one example of the magnetic head whose basic feature has been described in “SUMMARY” in the above description of each of the concrete embodiments, the magnetic head may be of plane recording type other than the vertical recording type magnetic head. The structure of the invention can also be applied to a case where the disposition of the recording element and the disposition of the reproducing element are reversed.

According to the embodiments of the magnetic head and the magnetic disk unit described above, the reproducing element is formed at a location closer to the slider than the recording element, and a distance between the reproducing element and the recording medium in a state where the slider floats is greater than a distance between the recording element and the recording medium. If the heater formed closer to the slider than the heat insulation layer formed between a coil of the recording element and the reproducing element is heated, the reproducing element formed on the side of the slider largely juts from the recording element and the reproducing element approaches the recording medium. Further, since heat from the heater is blocked by the heat insulation layer, the recording element is restrained from being deformed. Therefore, since the reproducing element having the longer distance than the recording medium largely juts as compared with the recording element, the distance between the recording element and the magnetic disk and the distance between the reproducing element and the magnetic disk are equalized.

According to the embodiments of the magnetic head and the magnetic disk unit disclosed herein, the distance between the recording element and the magnetic disk and the distance between the reproducing element and the magnetic disk are equalized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic head comprising:
a slider which floats above a recording medium by air flow generated by rotation of the recording medium; and
an element forming section fixed to an air outflow side of the slider and formed with an element which accesses the recording medium,
wherein the element forming section comprises:
a recording element having a main magnetic pole which records data in the recording medium,
a reproducing element which is formed closer to the slider than the recording element and which reproduces data recorded in the recording medium,
a heat insulation layer formed between the main magnetic pole and the reproducing element, and
a heater formed closer to the slider than the heat insulation layer.

2. The magnetic head according to claim 1, wherein the heater is formed between the heat insulation layer and the reproducing element.

3. The magnetic head according to claim 1, wherein the heat insulation layer is made of material having thermal conductivity of 1.5 W/mK or lower.

4. The magnetic head according to claim 2, wherein the heat insulation layer is made of material having thermal conductivity of 1.5 W/mK or lower.

5. A magnetic disk unit comprising:
a recording medium in which information is magnetically recorded;
a magnetic head which has a floating surface and floats such that the floating surface is oriented to a relatively moving recording medium, thereby recording information in the recording medium; and
an electronic circuit which supplies an electric signal to the magnetic head,
wherein the magnetic head comprises:
a slider which floats above the recording medium by air flow generated by rotation of the recording medium, and
an element forming section fixed to an air outflow side of the slider and formed with an element which accesses the recording medium, and
wherein the element forming section comprises:
a recording element having a main magnetic pole which records data in the recording medium,
a reproducing element which is formed closer to the slider than the recording element and which reproduces data recorded in the recording medium,
a heat insulation layer formed between the main magnetic pole and the reproducing element, and
a heater formed closer to the slider than the heat insulation layer.

6. The magnetic disk unit according to claim 5, wherein the heater is formed between the heat insulation layer and the reproducing element.

7. The magnetic disk unit according to claim 5, wherein the heat insulation layer is made of material having thermal conductivity of 1.5 W/mK or lower.
